(19) United States
(12) Patent Application Publication
(10) Pub. No.: US 2007/0058362 A1
(43) Pub. Date: Mar. 15, 2007

(54) Fire resistant glove illumination system

(76) Inventor: Kelly Winfrey, Milwaukee, WI (US)

Correspondence Address: Moss & Barnett P.A., 4800 Wells Fargo Center, 90 South Seventh Street, Minneapolis, MN, 55402-4129, US

(21) Appl. No.: 11/411,640

(22) Filed: Apr. 26, 2006

Related U.S. Application Data
(60) Provisional application No. 60/674,942, filed on Apr. 26, 2005.

(51) Int. Cl. F21V 21/08; A41D 19/00

(52) U.S. Cl. 362/103; 362/191; 2/160

(57) ABSTRACT

A fire-retardant glove illumination system comprising an illumination assembly removably disposed on a fire-retardant glove that is capable of emitting light before a firefighter as he or she crawls on the floor of a smoke-filled building. The illumination assembly includes a housing having a light in electrical communication with a power supply. The housing may be secured to an anchor that is detachably couplable to the glove. A tether may be coupled to the housing and/or the anchor for securing to an occupant of the smoke-filled building.

### CLAIM OF PRIORITY

This nonprovisional application claims the benefit of provisional application No. 60/674,942, filed Apr. 26, 2005, and incorporated herein by reference in its entirety.

### BACKGROUND OF THE INVENTION

1. Field of the Invention

The present invention relates to fire retardant gloves and more particularly pertains to a new fire resistant glove illumination system for illuminating an area in front a firefighter's hand or hands as they traverse through a smoke-filled building.

2. Description of the Prior Art

Everyday firefighters enter burning buildings filled with bellowing smoke and flames. More often than not, the smoke in the building is so thick that a firefighter's visibility is greatly restricted. Several devices have been developed to combat the thick smoke and to permit a firefighter to see while traversing through the building. For example, a simple handheld flashlight has been used for years to help firefighters find their way through a smoke-filled building. However, since smoke and heat rises firefighters are forced to crawl on the floor of the building. Crawling becomes very difficult if a firefighter's hand is occupied by a handheld flashlight. As a result, firefighters usually stop and shine the flashlight around to see or they drag the flashlight along the floor as they move. Either method of operating the handheld flashlight extends the time a firefighter is in the burning building, thereby increasing the risk of injury or death to the firefighter and/or trapped occupants of the building.

Eventually, non-handheld lighting devices were invented to resolve the above deficiency with the handheld flashlights. These devices typically consisted of a light attached a firefighter's head or helmet. However, since the smoke rises it is thicker at a firefighter's head than near the floor of the building. A similar effect is experienced by a driver driving a vehicle through a foggy area. The fog is typically thicker the further it is away from the ground or road. To combat the fog, vehicles are equipped with fog lights that are positioned closer to the ground so that the light shines underneath the fog.

There is a need in the firefighting industry for an illumination system that keeps a firefighter's hands free, but illuminates an area beneath the smoke of a smoke-filled building.

### SUMMARY OF THE INVENTION

A fire-retardant glove illumination system comprising a fire-retardant glove having a palm portion, a plurality of finger portions, and a thumb portion. An illumination assembly, capable of emitting light, is preferably removably disposed on an upper section of the palm portion. The illumination assembly is oriented on the fire-retardant glove such that the emitted light illuminates in a direction ahead of or before the firefighter's hand as he or she crawls upon the floor.

In an example embodiment, the illumination assembly includes a housing having a light such as at least one light emitting diode (LED) in electrical communication with a power supply. An actuating member such as a sliding switch, pushbutton or toggle switch may be disposed on the housing and in electrical communication with the light and power supply. The housing may be directly attached to the glove by any type of attachment means such as, for example, male-female snaps, hook and loop fastener, or any similar attachment.

In another example embodiment, the housing may be secured to an anchor that is detachably couplable to the glove. A hook and loop or similar attachment means may be attached to the anchor and the glove to permit removable attachment thereto. In yet another embodiment of the invention, a tether may be coupled to the housing and/or the anchor for securing to an occupant of the smoke-filled building. By placing the light on the occupant it permits the rescuing firefighter to more easily find the occupant in case of separation.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a fire retardant glove illumination system according to an example embodiment of the present invention.

FIG. 2 is a top plan view of a fire retardant glove illumination system according to an example embodiment of the present invention.

FIG. 3 is an end view of a fire retardant glove illumination system according to an example embodiment of the present invention.

FIG. 4 is a side view of an illumination assembly according to an example embodiment of the present invention.

FIG. 5 is a top view of the illumination assembly according to an example embodiment of the present invention.

FIG. 6 is a top view of the illumination assembly disposed on the fire-retardant glove according to an example embodiment of the present invention.

FIG. 7 is a side view of the illumination assembly disposed on the fire-retardant glove.

FIG. 8 is a front view of the illumination assembly disposed on a fire-retardant glove according to an example embodiment of the present invention.

FIG. 9 is a front view of the illumination assembly disposed on a fire-retardant glove according to an example embodiment of the present invention.

FIG. 10 is a top view of the illumination assembly disposed on a fire-retardant glove according to an example embodiment of the present invention.

The preceding description of the drawings is provided for example purposes only and should not be considered limiting. The following detailed description is provided for more detailed examples of the present invention. Other embodiments not disclosed or directly discussed are also considered to be within the scope and spirit of the present invention.

### DESCRIPTION OF THE PREFERRED EMBODIMENT

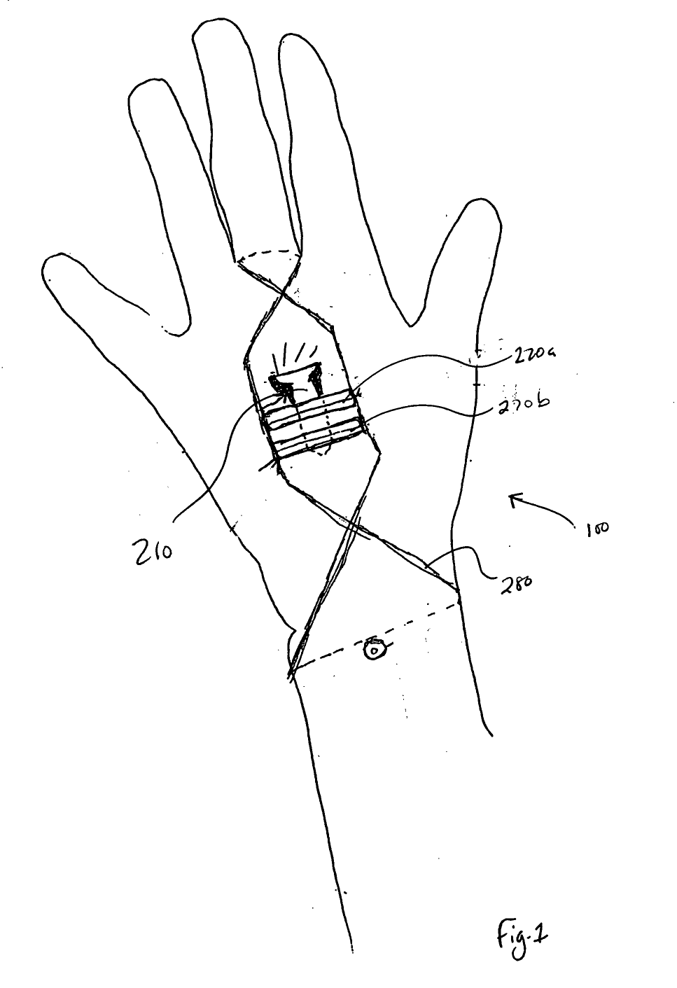

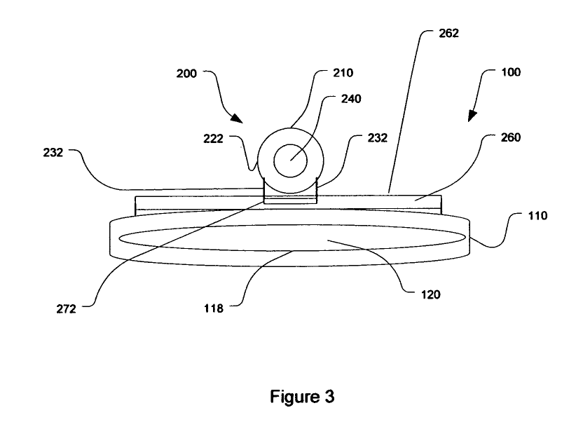

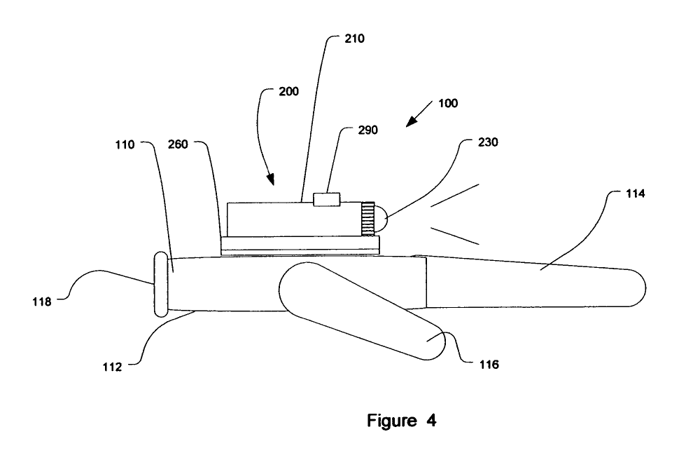

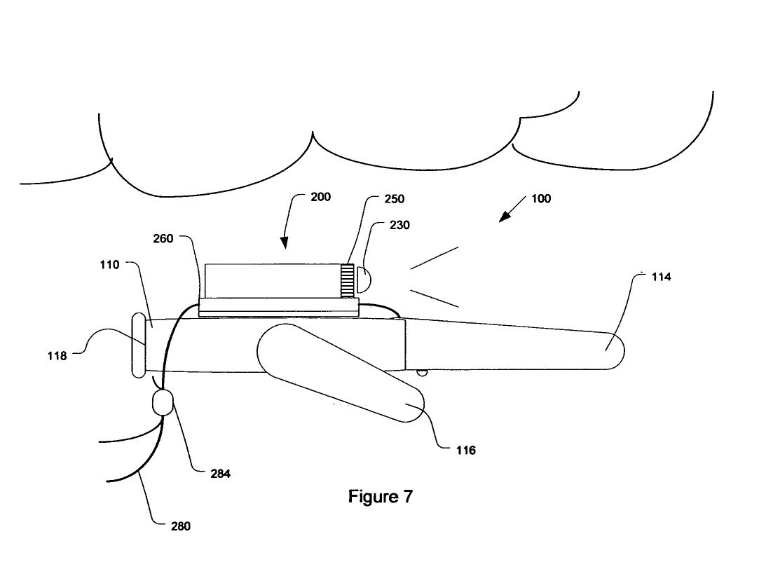

Referring to FIGS. 1-10, the fire-retardant glove illumination system, indicated by the number 100, includes a fire retardant glove 110 to protect the firefighter's hand while in a burning building. The fire-retardant glove 110 includes a palm portion 112, a plurality of finger portions 114, and a thumb portion 116. A closure 118 may be attached to or integrated about an aperture 120, FIG. 3, of the fire-retardant glove 110 to cinch about a wrist of the firefighter. The closure 120 may comprise a snap, elastic band, or other similar structure. The fire-retardant glove 110 may be manufactured from any fire-retardant material known to one skilled in the art.

Referring to FIGS. 1-7, an illumination assembly 200 is removably disposed to an upper section of the palm portion 112 of the glove 110 to permit a firefighter to illuminate an area before them as they crawl on the floor of a smoke-filled building. Additionally, placement of the illumination assembly 200 on top of the glove 110 permits a firefighter or anyone in need of a light source to illuminate an area before their hands without having to hold or grasp a flashlight or similar device.

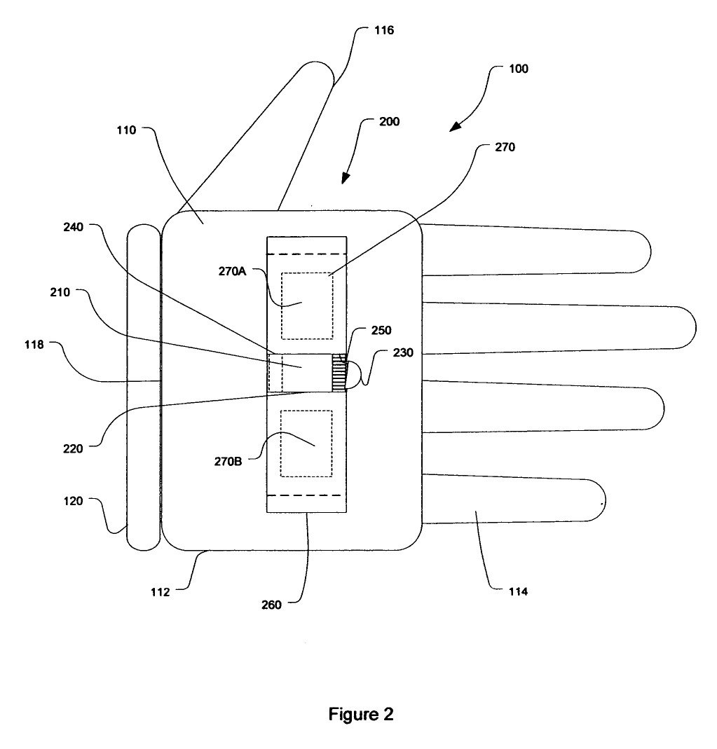

In an example embodiment of the present invention, the illumination assembly 200 includes a light 210 removably attached to the glove 110. Light 210 preferably includes a housing 220 having an interior 222 and a light emitter or source 230 operably disposed at least partially within the interior 222 of the housing 220. Referring particularly to FIG. 2, a power supply 240 is preferably disposed within the interior 222 of the housing 220 (see FIG. 3) and is operably coupled to the light emitter 232. Power supply 240 may be disposed in any location within the housing 220.

The light emitter 230 may comprise a light bulb, light emitting diode (LED), or similar light emitting device. The power supply 240 may comprise at least one watch battery, triple-A alkaline battery, or similar power source. In a preferred embodiment, the light 210 and all of its components are small and compact so as to fit on the glove 110 without interfering with the free movement of a firefighter's hand.

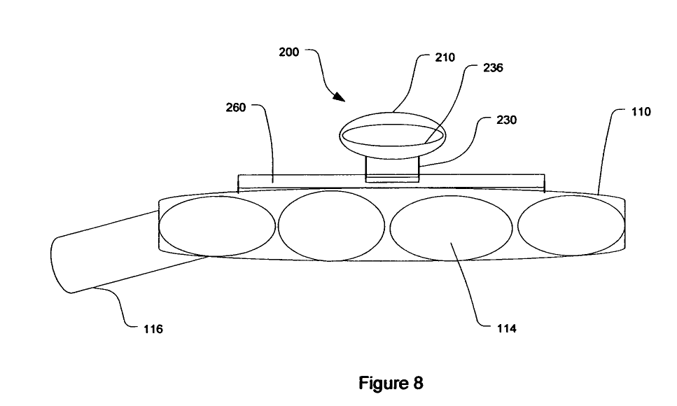

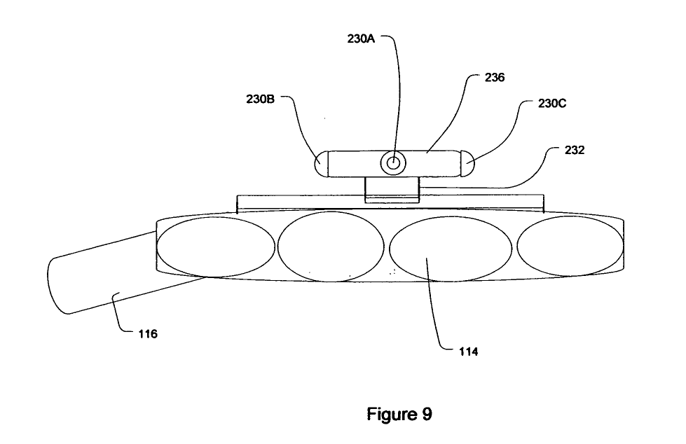

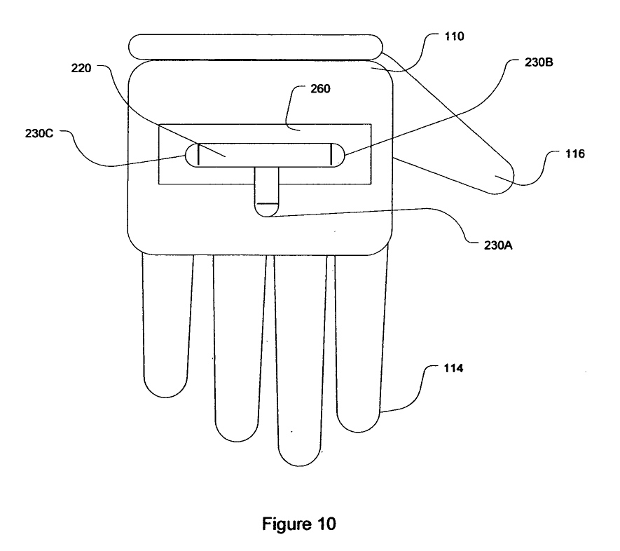

Referring to FIGS. 1-7, housing 220 can have a generally cylindrical shape with the light emitter 230 being generally disposed at an end of the housing 220. In this example embodiment, the disposition of the light emitter 230 at the end of the housing 220 permits light to emanate into and illuminate an area before the firefighter's hand. However, as illustrated in FIGS. 8 and 9, other shapes such as generally spherical, T-shaped, square, or similar shapes are also contemplated by the present invention. Referring particularly to FIG. 8, the housing 220 is generally spherical with a generally oblong light window 236 formed therein for permitting the light emitter 230 to illuminate generally a 180 degree area before the firefighter's hand. Referring to FIG. 10, housing 220 has a generally T-shape such that there are three ends with a light emitter 230 disposed in each end. A first light emitter 230A may be orientated to shine light in front of the firefighter. Second and third light emitters 230B and 230C respectively may be orientated to shine light to the sides of the firefighter. The second and third light emitters 230B and 230C may be generally opposed to each other and generally perpendicular to the first light emitter 230A. This particular embodiment illuminates areas proximate to the sides of the firefighter without requiring the firefighter to reposition his or her hand.

Referring back to FIG. 2, a power supply 240 is preferably disposed within the interior 222 of the housing 220 and in electrical communication with the light emitter or emitters 230-230C for selectively controlling a flow of power thereto. A watch battery, triple-A battery or similar type of battery may be used as a power supply.

A cap 250 may be threadedly disposed on the end of the housing 220 to selectively cover the light emitter or emitters 230-23C. The cap 250 preferably includes a transparent pane (not shown) to allow emitted light to flow passed the finger portions 114 or any portion of the glove 110 and into an area in front and/or on the sides of the firefighter.

Referring back to FIG. 2, housing 220 may be mounted on an anchor 260 that is removably or non-removably attached to the glove 110. Referring to FIG. 3, housing 220 may be mounted on a top surface 262 of the anchor 260. A fastening member 266 such as a hook and loop fastener, or snaps may be mounted to a bottom or lower surface 264 of the anchor 260 and the glove 110. In another embodiment, anchor 260 may be stitched or sewn on to the glove.

The anchor 260 may comprise a generally flexible rectangular strap of material such as canvas or other fabric that is fire-retardant.

As illustrated in FIGS. 2, and 5-6, a support 270 may be disposed on or in anchor 260 to provide generally rigid support for the housing 220 of the light 210. As particularly illustrated in the above figures, there may be at least two supports 270A and 270B disposed to the anchor 260. Each of the support 270A and 270B have a long axis generally perpendicular to a long axis of the housing 220 and parallel to a plane defined by the glove 110. In another example embodiment, only one support is utilized that extends generally across an entire length of the anchor 260. The support 270 may comprise any material that is generally rigid such as steel, aluminum, any plastic, or similar material.

Referring particularly to FIG. 3, a clip 270 may be removably coupled to housing 220 to removably clip the housing 220 to the anchor 260. Clip 270 is attached to a portion of the housing 220 and extendable generally along a length thereof. A free end of clip 270 may be removably slidable or insertable into a centrally disposed aperture 272 extending generally through or along a width of the anchor 270.

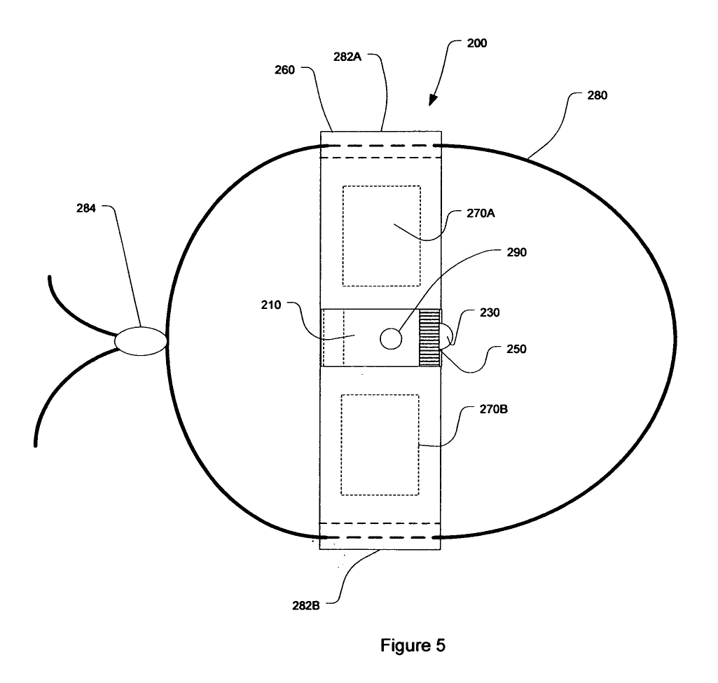

In an example embodiment, as illustrated in FIGS. 5-7, a tether 280 may be operably coupled to anchor 260 and glove 110 to secure the light 210 to the fire-retardant glove 110. As illustrated in FIG. 5, the tether 280 may comprise a single length of material such as rope, thread, string, or similar material that is slidably threaded through at least two apertures 282A and 282B formed in the anchor 260. Apertures 282A and 282B are preferably disposed at opposed ends of the anchor 260 to ensure proper positioning of the light 210 on the fire-retardant glove 110. An adjustable coupler 284 is preferably disposed on the tether 280 to secure ends of the tether 280 together and to adjust the tether 280 to the fire-retardant glove 110.

In another embodiment, a user may utilize the illumination assembly 200 without the glove 110. In this embodiment, the tether 280 is tied around at least one finger and the wrist of the user such that the anchor 260 is disposed on an upper surface of the hand. In another embodiment, the tether 280 may be an elastic material. In this embodiment, the tether 280 may be extendable about a palm of a user with the anchor 260 and light 220 disposed on the upper surface of the hand.

An actuating member 290 may be disposed on the housing 220 and operably coupled to the power supply 240 to permit selective operation of the light 210. The actuating member 290 may comprise a sliding switch, rotary switch, pushbutton switch, or similar switch.

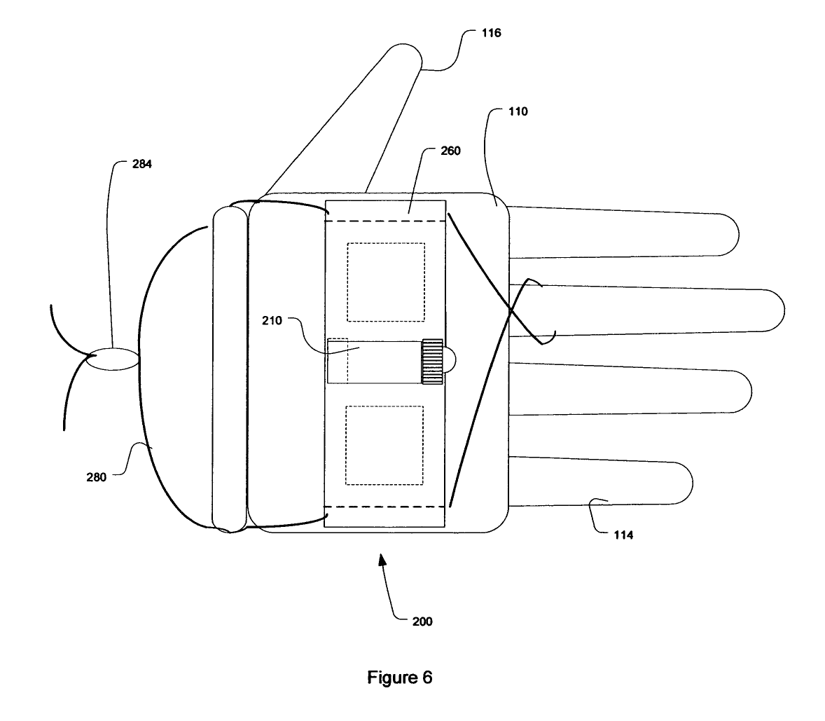

In use, a firefighter or any user such as a mechanic or police officer attaches the light 220 to the glove 110. If a tether 280 is being utilized a user inserts his or her hand into the glove 110 with the adjustable coupler 284 disposed below the wrist. A portion of the tether 280, proximate fingers 114 of the glove 110, is twisted or folded, as illustrated in FIG. 6, to form a loop that is disposed about at least one finger 114 of the glove 110. The coupler 284 is then slid toward the user's wrist to tighten and secure the illumination assembly 200 to the glove 110.

Once in a smoke-filled building the firefighter actuates the light 210 by sliding the actuating member 290 to an ON position. The firefighter may then direct his or her hand in any direction that needs to be illuminated. If a firefighter is forced to crawl on the floor due to the denseness of the smoke, the firefighter's hand and light 210 are disposed adjacent to the floor and below the smoke. Since the light 210 is below the smoke it is able to emanate further thereby illuminating a larger area before the firefighter. When a firefighter utilizes the spherical or T-shaped embodiment of the invention, the areas to his or her sides are illuminated; thereby permitting a firefighter to simply rotate his or her head to examine the side areas.

If a firefighter encounters an occupant in the smoke-filled room, the light 210 may be detached from the glove 110 and attached to the occupant. Typically, the tether 280 may be secured around the occupant's wrist or neck. Attaching the light 210 to the occupant permits them to be more easily located if they become separated from the firefighter. In one example embodiment of the invention, the light emitter 230 may flash or may emit an occupant/firefighter specific color. Having lights of different colors or rates of flashing permit other firefighters and rescue personnel to easily discern who is in the building. In yet another embodiment of the invention, disposing location circuitry such as global positioning circuitry in the housing permits a supervisor to easily monitor who is in the building and their proximate locations.

A police officer may also utilize the illumination assembly 200 on his or her weapon-holding-hand. Attaching the illumination assembly 200 to the weapon-holding-hand permits the officer to illuminate an area before the weapon without having to hold onto a separate flashlight. Additionally, the officer's non-weapon or free hand is now able to steady the weapon. If the user does not need to steady the weapon, his or her free hand may be used to operate handcuffs or pepper spray.

The present invention may also be utilized by mechanics or similar occupations to permit a user to illuminate a working area without having to hold a flash light. The present invention illuminates a work area while permitting the user to have both hands free to focus on the task or job.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A fire resistant glove illumination system comprising:
a glove;
an illumination assembly being mountable on the glove for illuminating an area about the glove; and
a power supply being operatively connected to the illumination assembly.

2. The system of claim 1, wherein the glove has a palm portion, a plurality of finger portions and a thumb portion, wherein the illumination assembly is mountable to the palm portion.

3. The system of claim 1, wherein the glove has a palm portion, a plurality of finger portions and a thumb portion, wherein the illumination assembly is mountable proximate the finger portions.

4. The system of claim 1, wherein the illumination assembly comprises a housing having a light to illuminate the area about the glove and an actuator to control an operation of the light.

5. The system of claim 4, further comprising at least one anchor disposed between the housing and the glove to secure the housing to the glove.

6. The system of claim 4, further comprising at least one tether disposed between the housing and the glove to secure the housing to the glove, wherein the at least one tether is securable about the glove.

7. The system of claim 4, wherein the light is a light emitting diode.

8. The system of claim 4, wherein the light is a light bulb.

9. The system of claim 5, wherein the at least one anchor is a hook and loop fastener disposed on and between the glove and the housing.

10. The system of claim 4, wherein the housing has a generally cylindrical shape, thereby permitting light to illuminate a front area before the glove.

11. The system of claim 4, wherein the housing has a generally T-shape with a plurality of ends and at least one light being operatively disposed to each end, thereby permitting light to illuminate a front area before the glove and side areas lateral to the glove.

12. The system of claim 4, wherein the housing has a generally spherical shape with lights being operatively disposed about its circumference, thereby permitting light to illuminate at least a 180 degree area in front of the glove.

13. The system of claim 5, wherein the at least one anchor is at least one generally flexible strap.

14. The system of claim 13, further having at least one generally rigid support disposed in the at least one anchor to provide additional support to the housing.

15. The system of claim 5, further comprising a clip mountable to the housing and removably insertable into an aperture extending into the anchor.

16. The system of claim 6, wherein the at least one tether is disposed through opposed apertures of the anchor, wherein an adjustable coupler is disposed on the tether to secure ends of the tether together.

17. A method of illuminating an area before a firefighter comprising the steps of:
placing a glove on a user's hand; and
detachably mounting an illumination assembly on the glove for illuminating an area about the glove;
connecting a power supply to the illumination assembly;
activating an actuator to illuminate the illumination assembly.

18. The method of claim 17, further comprising the step of having a user illuminate an area by pointing their hand in a direction of the area to be illuminated.

19. The method of claim 17, further comprising the step of crawling below a fire and smoke and illuminating an area beneath the smoke with the illumination assembly.

20. The method of claim 17, further comprising the step of removing the illumination assembly from the glove and placing it on an alternate user as an indicator of the alternate user's location.
